(19) United States
(12) Patent Application Publication
(10) Pub. No.: US 2013/0226667 A1
(43) Pub. Date: Aug. 29, 2013

(54) METHODS AND APPARATUS TO ANALYZE MARKETS BASED ON AERIAL IMAGES

(71) Applicants: Alex Terrazas, Santa Cruz, CA (US); David Miller, Annandale, VA (US); Paul Donato, New York, NY (US)

(72) Inventors: Alex Terrazas, Santa Cruz, CA (US); David Miller, Annandale, VA (US); Paul Donato, New York, NY (US)

(21) Appl. No.: 13/774,790

(22) Filed: Feb. 22, 2013

Related U.S. Application Data
(60) Provisional application No. 61/602,423, filed on Feb. 23, 2012.
(60) Provisional application No. 61/603,756, filed on Feb. 27, 2012.

(51) Int. Cl. G06Q 30/02

(52) U.S. Cl. CPC G06Q 30/0205
USPC 705/7.34

(57) ABSTRACT

Methods and apparatus to analyze market channels based on aerial images are disclosed. An example method includes determining, using a processor, whether a first element in an aerial image of a geographic area represents a man-made object; determining, using the processor, whether a second element in the aerial image represents a natural object; and estimating a market channel for the geographic area based on a second market channel for a second geographic area when the first element represents a man-made object and the second element represents a natural object

### RELATED APPLICATION

This patent claims priority to U.S. Provisional Patent Application Ser. No. 61/602,423, which was filed on Feb. 23, 2012, and to U.S. Provisional Patent Application Ser. No. 61/603,756, which was filed on Feb. 27, 2012, the entireties of which are hereby incorporated herein by reference.

### FIELD OF THE DISCLOSURE

This disclosure relates generally to analyzing markets and, more particularly, to methods and apparatus to analyze markets based on aerial images.

### BACKGROUND

Market channels are described by supply, such as product delivery capacity, numbers of stores, and product availability, and by demand, such as an amount of product sold and which types of merchants (e.g., retail outlets, wholesalers, club stores, etc.) sell the products. Market channels vary between geographic locations and over time.

### BRIEF DESCRIPTION OF THE DRAWINGS

FIG. 1 is a block diagram of an example system constructed in accordance with the teachings of this disclosure to analyze markets based on aerial images.

FIG. 2 illustrates an example aerial image including geographic border areas including man-made objects and natural objects.

FIG. 3 illustrates a portion of the aerial image of FIG. 2 including an example geographic border area.

FIG. 4 illustrates another example aerial image including geographic border areas between different areas having different socioeconomic statuses.

FIG. 5 illustrates an example market channel sampling path through a geographic border area based on the aerial image of FIG. 4.

FIG. 6 is a flowchart representative of example computer readable instructions which may be executed to estimate a market channel based on aerial images.

FIG. 7 is a flowchart representative of example computer readable instructions which may be executed to generate a sampling path to sample a geographic area based on aerial images.

FIG. 8 is a flowchart representative of example computer readable instructions which may be executed to estimate development of a geographic area based on aerial images.

FIG. 9 is a flowchart representative of example computer readable instructions which may be executed to initiate crowdsourcing of information about a geographic area based on aerial images.

FIG. 10 is a block diagram of an example processor platform capable of executing the instructions of FIGS. 6, 7, 8, and/or 9 to implement the apparatus of FIG. 1.

The figures are not to scale. Wherever possible, the same reference numbers will be used throughout the drawing(s) and accompanying written description to refer to the same or like elements.

### DETAILED DESCRIPTION

Traditional methods for enumerating stores employ human surveyors. Such traditional methods suffer from many shortcomings including high costs, low temporal resolution, and/or an inability to estimate markets in many areas due to dangerous conditions and/or geopolitical reasons.

Aerial imaging (e.g., satellite-based photography, aircraft-based photography, satellite-based infrared imaging, etc.) offers a number of capabilities for estimating commercial activity in developing and/or developed geographic areas. Example methods and apparatus disclosed herein analyze aerial images of geographic areas of interest to provide more efficient and/or cost-effective ways to estimate market channel information than traditional sampling methods. In some examples, upper and/or lower bounds on market channel estimates are obtained from known ground truth (e.g., market channel sampling performed on a different but similar area).

In some examples, objects and/or areas are classified as man-made and/or natural based on an analysis of an aerial image. Areas that transition from natural to man-made (e.g., urban) may be designated as border zones or watch areas. In some examples, aerial images of the border zones from different times are compared to trigger sampling of the areas and/or estimation of market channels based on similar areas. The use of border areas and/or watch areas reduces an amount of satellite imagery to be acquired and/or limits an amount of processing to be performed for feature extraction from the aerial images.

Example methods and apparatus disclosed herein analyze aerial images to generate sampling paths for sampling a geographic area, estimate future development including market channels, and/or initiate crowdsourcing of market channel information by establishing a crowdsourcing platform.

As used herein, a “market channel” refers to a path of a product of interest as it moves from a producer to an ultimate consumer or user. As used herein, sampling a market channel refers to the process of physically counting instances of an object of interest, such as a product or a store type, within a designated area. Market sampling can be used to extrapolate a counted number to a number representing the entire designated area. As used herein, the term “crowdsourcing” refers to obtaining information from a collective of individuals (e.g., the general public, a knowledgeable group of persons) for a designated purpose (e.g., a project). Persons contributing information for the designated purpose may be compensated or not compensated for time and effort spent providing the information. As used herein, the term “sampling path” refers to a defined route through a geographic area, along which an individual is performing sampling of one or more items of interest (e.g., stores, products, etc.).

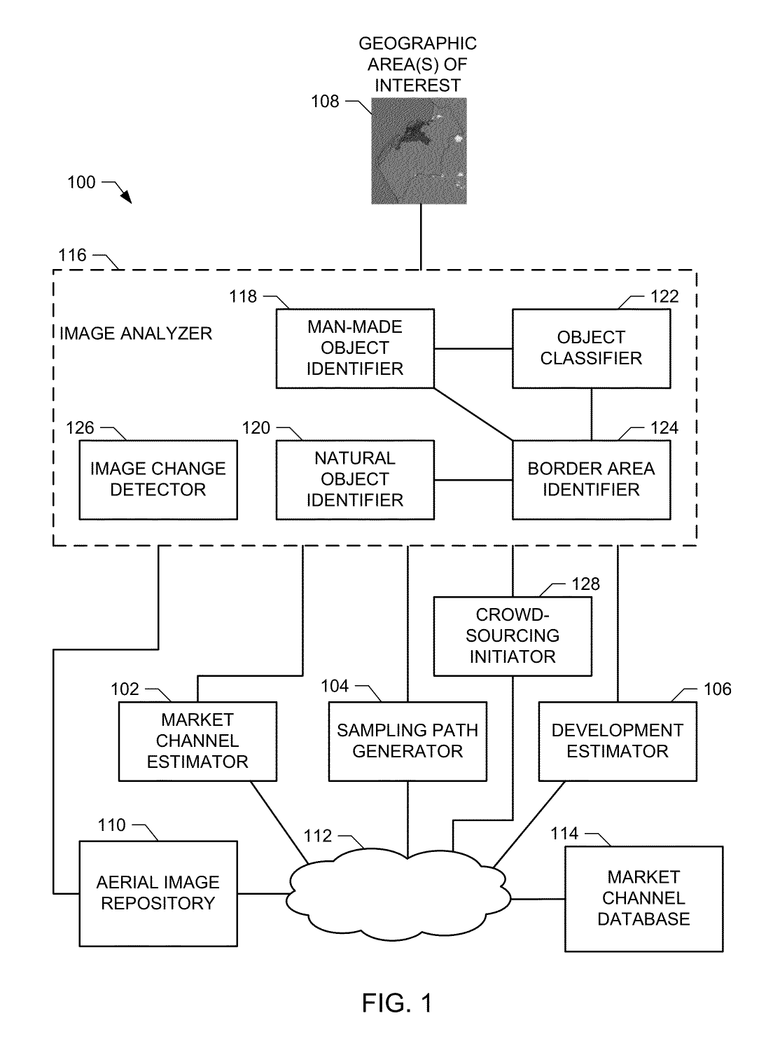

FIG. 1 is a block diagram of an example system 100 to analyze markets based on aerial images. For example, the system 100 may be used to estimate market channels within a geographic area of interest based on aerial image(s) of the geographic area, generate sampling paths for sampling a market within a geographic area based on aerial image(s) of the geographic area, estimate development of a geographic area based on aerial image(s) of the geographic area, and/or initiate crowdsourcing of market channel information, among other things.

The example system 100 of FIG. 1 includes a market channel estimator 102, a sampling path generator 104, and a development estimator 106. Individually and/or collectively, the market channel estimator 102, the sampling path generator 104, and/or the development estimator 106 may be used to analyze market channels of a geographic area of interest 108. For example, the market channel estimator 102, the sampling path generator 104, and/or the development estimator 106 may receive a digital representation of and/or an identification of a geographic area of interest 108 to be analyzed. In some examples, a digital representation (e.g., an image) of the geographic area of interest 108 is processed and/or analyzed to define subregions (also referred to herein as subareas) within the image of the geographic area of interest 108 that fit particular criteria and/or have particular characteristics.

The example system 100 of FIG. 1 further includes an aerial image repository 110 that provides image(s) of the specified geographic area of interest 108 to a requester (e.g., via a network 112 such as the Internet. The example images may include aerial-generated images and/or satellite-generated images having any of multiple sizes and/or resolutions (e.g., images captured from various heights over the geographic areas). Example satellite and/or aerial image repositories that may be employed to implement the aerial image repository 110 are available from DigitalGlobe®, GeoEye®, RapidEye, Spot Image®, and/or the U.S. National Aerial Photography Program (NAPP). The example aerial image repository 110 of the illustrated example may additionally or alternatively include geographic data such as digital map representations, source(s) of population information, building and/or other man-made object information, and/or external source(s) for parks, road classification, bodies of water, etc.

The example market channel estimator 102 of FIG. 1 determines which, if any, elements in an aerial image of a geographic area represent man-made objects and/or natural objects, and estimates a market channel for a geographic area. In the illustrated example, the estimate is based on a market channel for a similar geographic area based on the composition of elements in the aerial image. For example, the market channel estimator 102 of the illustrated example identifies an area containing a boundary between man-made objects and natural objects. In other examples, the market channel estimator 102 identifies an area between a first class of man-made objects (e.g., man-made objects indicative of a higher socioeconomic status) and a second class of man-made objects (e.g., man-made objects indicative of a lower socioeconomic status). Such areas may indicate areas of development in which new market channels are likely to emerge (or may have recently emerged).

When the market channel estimator 102 of the illustrated example identifies an area in which a market channel is likely to emerge or may have recently emerged, the market channel estimator 102 of the illustrated example estimates one or more market channels (e.g., the types of certain products and/or product types, the demand for certain products and/or product types, supply costs for products and/or product types, a number of a designated product available for purchase in the geographic area or a number of different products of a designated type that are available for purchase in the geographic area, etc.) based on sampled market channels in similar areas. The example market channel estimator 102 of FIG. 1 accesses market channel information for areas similar to the geographic area of interest 108 from a market channel database 114 (e.g., via the network 112). The market channel database 114 stores market channel information derived from sampling or other market knowledge. In some examples, the market channel information is stored in association with geographic information and/or characteristics that may be determined from an aerial image.

The example sampling path generator 104 of FIG. 1 identifies a geographic border area between a first region having a first type (e.g., a man-made region, a region having a higher average socioeconomic status or class) and a second region having a second type (e.g., a natural area, a region having a lower average socioeconomic status or class) based on a first aerial image. The example sampling path generator 104 of the illustrated example generates a sampling path to guide the efficient sampling of a market channel in the identified area when, for example, a threshold change is identified in the identified area based on the first aerial image and a second aerial image of the identified area taken at a different time than the first aerial image.

The example development estimator 106 of FIG. 1 identifies a geographic area containing man-made objects based on an aerial image and classifies at least a subset of the man-made objects. The development estimator 106 of the illustrated example calculates a likelihood of future development in the geographical area based on, for example, a distance between a designated location in the geographic area (e.g., the center) and another location (e.g., a social and/or civic center, a retail center, or another type of location) or a distance between a designated location in the geographic area and a designated transportation resource (e.g., a major transportation artery such as a highway or main thoroughfare). The example development estimator 106 of FIG. 1 estimates the likelihood of future development (e.g., future emergence of one or more market channels) based on the classification of the geographic area and/or based on historical development as a function of such classifications.

To process aerial images obtained from the aerial image repository 110, the example system 100 of FIG. 1 includes an image analyzer 116. The example image analyzer 116 of FIG. 1 obtains aerial image(s) of the geographic area(s) of interest 108 from the aerial image repository 110. The image analyzer 116 performs image analysis, such as the processes described below, to identify man-made object(s) and/or natural objects in the aerial image(s), to identify borders between different areas and/or identify border areas in the aerial image(s), to classify objects and/or portions of the aerial image(s), and/or to detect change(s) in images taken at different times of the same or overlapping geographic area. The image analyses performed by the image analyzer 116 of the illustrated example is provided to the example market channel estimator 102 (e.g., to estimate market channel(s) in a geographic area), to the sampling path generator 104 (e.g., to generate a sampling path through a geographic area), and/or to the development estimator 106 (e.g., to estimate a likelihood of development in a geographic area).

The example image analyzer 116 of FIG. 1 includes a man-made object identifier 118, a natural object identifier 120, an object classifier 122, a border area identifier 124, and an image change detector 126.

The example man-made object identifier 118 of FIG. 1 analyzes an aerial image to identify man-made objects and/or regions containing man-made objects within the aerial image. Example identifiable man-made objects include buildings, roadways, driveways, fences, tennis courts, city blocks, and/or swimming pools. For example, the man-made object identifier 118 performs Radon transforms of the aerial image to identify straight lines, which are indicative of man-made objects rather than natural objects. The man-made object identifier 118 may further identify circular objects (e.g., round swimming pools), colored objects (e.g., rooftops, swimming pools, or other unusually and/or unnaturally colored objects), and/or any other distinguishing feature of man-made objects observable from the aerial image(s).

The example natural object identifier 120 of FIG. 1 analyzes the aerial image to identify natural (i.e., not man-made) objects and/or regions of natural objects (e.g., undeveloped natural areas). Natural objects may include, for example, trees, forests, bodies of water, rocky areas, and/or other types of natural objects or areas. In some examples, the natural object identifier 120 ignores man-made natural areas or objects such as parks. To identify natural objects, the example natural object identifier 120 of the illustrated example applies one or more of image transform(s), pattern matching, and/or noise measurement on an image to identify natural objects. Because natural objects rarely have the straight lines characteristic of man-made objects, they can be identified by their lack of straight lines.

The example object classifier 122 of FIG. 1 classifies objects identified by the man-made object identifier 118 and/or the natural object identifier 120. For example, the object classifier 122 of the illustrated example distinguishes between different man-made objects by determining socioeconomic and/or demographic characteristics of a group of closely-positioned man-made objects. The example object classifier 122 of the illustrated example also classifies natural objects. For example, a natural object may be classified as part of a natural area (e.g., if the object is surrounded by other natural objects, or is sufficiently far from a man-made object) and/or as part of a developed area (e.g., a natural object in a park).

The example border area identifier 124 of FIG. 1 identifies geographic areas that include borders between two or more different types of areas. For example, a border may exist between an area, subregion, or subarea including man-made objects and another area, subregion, or subarea including natural objects (e.g., not including man-made objects). In another example, a border may exist between different areas or subareas that have different socioeconomic and/or demographic classifications.

The example image change detector 126 of FIG. 1 identifies a change in a geographic area between multiple images of the geographic area taken at different times. In other words, the example image change detector 126 evaluates the change in a geographic area over time. In some examples, the image change detector 126 compares the change to a threshold amount of change to determine, for example, whether previous estimates or measurements of market channels in the area are likely to be obsolete or incorrect. A change in a geographic area that exceeds a threshold may trigger the generation of updated market channel sampling plans for the geographic area and/or the generation of new estimates of market channels for the geographic area based on different market channel information in the market channel database 114 than was used to previously estimate market channels for the geographic area.

The example system 100 of FIG. 1 further includes a crowdsourcing initiator 128. The example crowdsourcing initiator 128 initiates crowdsourcing of the geographic area of interest 108. In some examples, the crowdsourcing initiator 128 initiates crowdsourcing by constructing a suitable platform (e.g., a web site and a database) to enable persons in the geographic area of interest 108 to respond to requests and/or to voluntarily provide market channel information over the Internet rather than directly sampling the geographic area of interest 108. The example crowdsourcing initiator 128 of FIG. 1 initiates crowdsourcing of market channel information in response to, for example, the image change detector 126 detecting a threshold amount of change between aerial images of the geographic area of interest 108. When a crowdsourcing platform is constructed for the geographic area of interest 108, persons may be permitted to enter market channel information such as product availability and/or retail store information by designating a location on a map or on the aerial image and indicating the product and/or store of purchase.

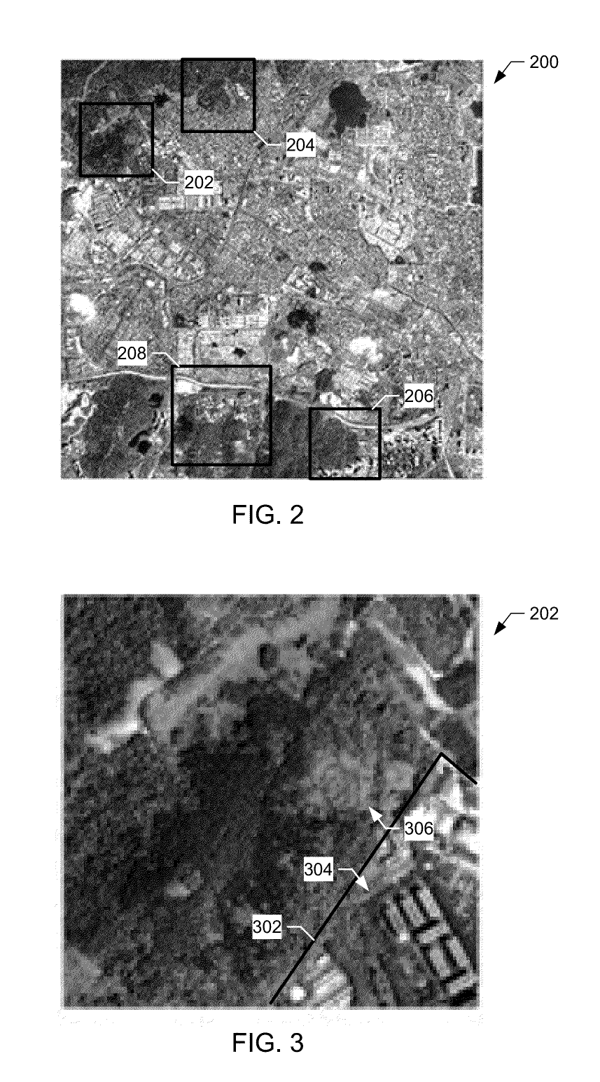

FIG. 2 illustrates an example aerial image 200 including geographic border areas 202, 204, 206, 208 including man-made objects and natural objects. The example aerial image 200 of FIG. 2 may be provided by the aerial image repository 110 of FIG. 1 in response to a request by the image analyzer 116 for an image of a geographic area of interest 108.

The example border area identifier 124 of FIG. 1 identifies the example geographic border areas 202-208 of FIG. 2 based on identifications of man-made objects and natural objects in the respective geographic border areas 202-208. For example, the man-made object identifier 118 of FIG. 1 performs a Radon transform of the aerial image 200 to identify man-made objects in the aerial image. The example natural object identifier 120 identifies natural objects (e.g., trees, undeveloped areas, etc.) in the example aerial image 200. The man-made object identifier 118 and the natural object identifier 120 output identifications of subregions (e.g., contiguous subregions having one or more similar or identical characteristics) of the aerial image 200 (or geographic coordinates representative of the subregions) that include man-made objects and natural objects, respectively. Additionally or alternatively, the man-made object identifier 118 and the natural object identifier 120 output identifications (e.g., locations) of man-made objects and natural objects present in the aerial image.

While example border areas 202-208 are identified in FIG. 2, additional and/or alternative border areas may be identified. Furthermore, the example border areas 202-208 may have any appropriate shape and/or size. In some examples, identified border areas 202-208 are permitted to overlap.

FIG. 3 illustrates an enlarged portion of the aerial image 200 of FIG. 2 corresponding to an example geographic border area 202. Upon receiving identifications of the man-made objects, the example border area identifier 124 of FIG. 1 determines border(s) 302 between subregions of a first type 304 (e.g., areas including man-made objects, developed areas, etc.) and subregions of a second type 306 (e.g., natural areas, undeveloped areas, etc.). For example, the border area identifier 124 of FIG. 1 may identify developed areas 304 (e.g., by identifying straight lines in the subregion 304 using, for example, a Radon transform) that are adjacent undeveloped areas 306. The border area identifier 124 may flag or output identifiers of the border area 202-208. The example border 302 may be used, for example, to later identify changes in the border area 202. The example crowdsourcing initiator 128 of FIG. 1 may initiate crowdsourcing of market channel information for the border area 202.

The example market channel estimator 102, the example sampling path generator 104, and/or the example development estimator 106 obtain identifications of the border area 202. In the illustrated example, the market channel estimator 102 estimates market channels in the border area 202. The example sampling path generator 104 of FIG. 1 determines sampling paths for sampling the border area 202. The example development estimator 106 of FIG. 1 estimates a likelihood of future development in the border area 202.

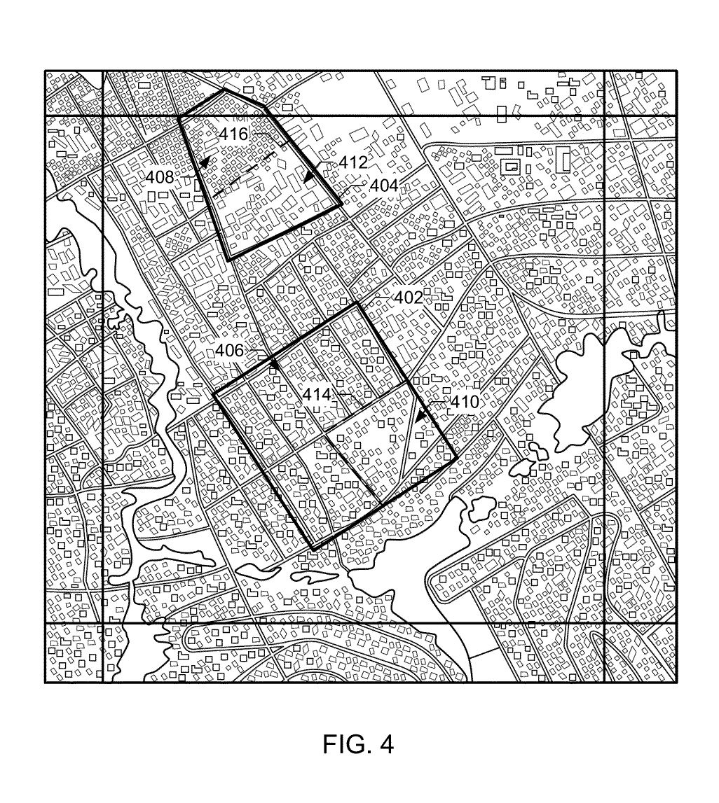

FIG. 4 illustrates another example aerial image 400 including geographic border areas 402, 404 between different areas having different socioeconomic statuses. The example areas 402, 404 of FIG. 4 each include a first area 406, 408 having a lower estimated average socioeconomic status and a second area 410, 412 having a higher estimated average socioeconomic status.

The example object classifier 122 of FIG. 1 classifies man-made objects (e.g., buildings, roads, etc.) identified via the man-made object identifier 118. For example the object classifier 122 of the illustrated example classifies objects as having particular characteristics based on the aerial image 400. The entire example region represented by the aerial image 400 may have previously been classified as developed or man-made region. Example characteristics that may be determined and/or estimated (e.g., deduced) include building size, building density, road width, amounts of open spaces, socioeconomic characteristics (e.g., estimated average income, presence of luxuries such as swimming pools or tennis courts, etc.), demographic characteristics (e.g., average household size, average household age, etc.). Based on the classification(s), the example object classifier 122 of the illustrated example generates contiguous subregions having similar characteristics. The example border area identifier 124 identifies borders 414, 416 between two or more groupings of characteristics.

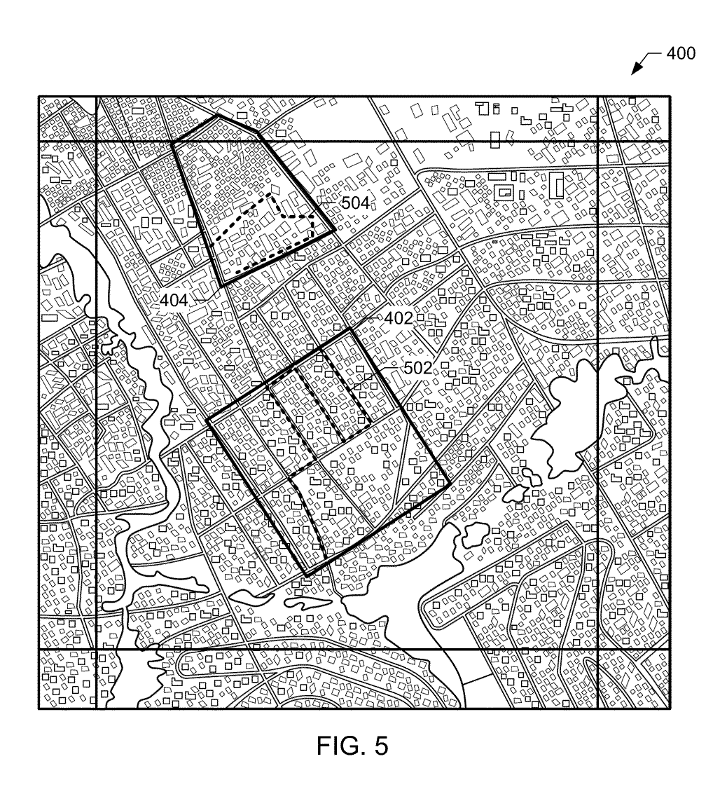

FIG. 5 illustrates example market channel sampling paths 502, 504 through the geographic border areas 402, 404 based on the aerial image 400 of FIG. 4. The example sampling path generator 104 of FIG. 1 generates the market channel sampling paths 502, 504 of FIG. 5 based on, for example, the characteristics of the geographic areas 402, 404 and/or subregions (e.g., subregions 406-412 of FIG. 4) of the geographic areas 402, 404. For example, the market channel sampling paths 502, 504 may be determined based on estimates of where store locations and/or products of interest are predicted to be found. Store locations and/or products of interest may be based on identifying stores via the aerial images and/or based on market channel information (e.g., associations of store locations and/or types with building information, store densities, descriptions of likely store locations, etc.) from the market channel database 114.

While an example manner of implementing the system 100 is illustrated in FIG. 1, one or more of the elements, processes and/or devices illustrated in FIG. 1 may be combined, divided, re-arranged, omitted, eliminated and/or implemented in any other way. Further, the example market channel estimator 102, the example sampling path generator 104, the example development estimator 106, the example aerial image repository 110, the example market channel database 114, the example image analyzer 116, the example man-made object identifier 118, the example natural object identifier 120, the example object classifier 122, the example border area identifier 124, the example image change detector 126, the example crowdsourcing initiator 128 and/or, more generally, the example system 100 of FIG. 1 may be implemented by hardware, software, firmware and/or any combination of hardware, software and/or firmware. Thus, for example, any of the example market channel estimator 102, the example sampling path generator 104, the example development estimator 106, the example aerial image repository 110, the example market channel database 114, the example image analyzer 116, the example man-made object identifier 118, the example natural object identifier 120, the example object classifier 122, the example border area identifier 124, the example image change detector 126, the example crowdsourcing initiator 128 and/or, more generally, the example system 100 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example, market channel estimator 102, the example sampling path generator 104, the example development estimator 106, the example aerial image repository 110, the example market channel database 114, the example image analyzer 116, the example man-made object identifier 118, the example natural object identifier 120, the example object classifier 122, the example border area identifier 124, the example image change detector 126, and/or the example crowdsourcing initiator 128 is hereby expressly defined to include a tangible computer readable storage device or storage disc such as a memory, DVD, CD, Blu-ray, etc. storing the software and/or firmware. Further still, the example 100 of FIG. 1 may include one or more elements, processes and/or devices in addition to, or instead of, those illustrated in FIG. 1, and/or may include more than one of any or all of the illustrated elements, processes and devices.

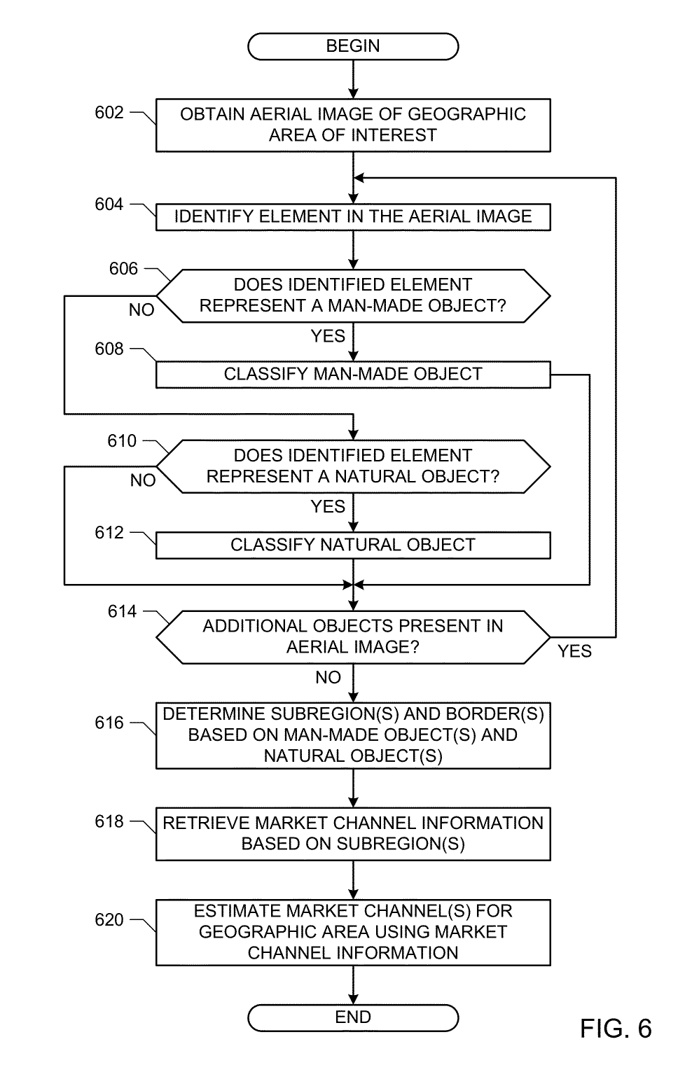

Flowcharts representative of example machine readable instructions for implementing the system 100 of FIG. 1 are shown in FIGS. 6, 7, 8, and/or 9. In this example, the machine readable instructions comprise a program for execution by a processor such as the processor 1012 shown in the example processor platform 1000 discussed below in connection with FIG. 10. The programs may be embodied in software stored on a tangible computer readable storage medium such as a CD-ROM, a floppy disk, a hard drive, a digital versatile disk (DVD), a Blu-ray disk, or a memory associated with the processor 1012, but the entire programs and/or parts thereof could alternatively be executed by a device other than the processor 1012 and/or embodied in firmware or dedicated hardware. Further, although the example programs are described with reference to the flowcharts illustrated in FIGS. 6-9, many other methods of implementing the example system 100 may alternatively be used. For example, the order of execution of the blocks may be changed, and/or some of the blocks described may be changed, eliminated, or combined.

As mentioned above, the example processes of FIGS. 6, 7, 8, and/or 9 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 6, 7, 8, and/or 9 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

FIG. 6 is a flowchart representative of example computer readable instructions 600 which may be executed to estimate a market channel based on aerial images. The example instructions may be executed to implement, for example, the image analyzer 116, the aerial image repository, the market channel database 114, and/or the market channel estimator 102 of FIG. 1.

The example image analyzer 116 obtains an aerial image of a geographic area of interest (block 602). For example, the image analyzer 116 may request and receive an aerial picture or a satellite picture from the aerial image repository 110 of FIG. 1. The example image analyzer 116 (e.g., via the man-made object identifier 118 and/or the natural object identifier 120) identifies an element in the aerial image (block 604). The example man-made object identifier 118 determines whether the identified element represents a man-made object (block 606). For example, the man-made object identifier 118 may apply one or more transformations (e.g., the Radon transform) to the aerial image and/or the identified element to determine whether the identified element is a man-made object. If the identified element represents a man-made object (block 606), the example object classifier 122 classifies the man-made object (block 608). Classifying may include, for example, determining additional characteristics of the object, such as size, shape, distance to adjacent objects (e.g., object density), distance from the object to another location, estimated socioeconomic status, color, and/or any other characteristics.

If the identified element does not represent a man-made object (block 606), the example natural object identifier 120 of FIG. 1 determines whether the identified element represents a natural object (block 610). For example, the natural object identifier 120 may analyze the aerial image to determine whether the identified object is in a natural area or otherwise indicates that the identified object is a natural object (e.g., is not man-made). If the identified object is a natural object, the example object classifier 122 classifies the natural object (block 612).

After classifying the object (block 608 or block 612), or if the identified element is not determined to represent a man-made object or a natural object (e.g., due to uncertainty or due to a misidentification of an object) (blocks 608 and 610), the example image analyzer 116 determines whether any additional objects are present in the aerial image (block 614). If there are additional objects in the aerial image (block 614), control returns to block 604 to identify another element in the aerial image.

When there are no further objects present in the aerial image (block 614), the example border area identifier 124 of FIG. 1 determines subregion(s) and border(s) between the subregion(s) based on the man-made object(s) and the natural object(s) in the geographic area (block 616). For example, the border area identifier 124 may group similarly-classified objects into substantially contiguous areas (e.g., according to the aerial image) to determine the subregion(s) and determine borders between the subregion(s).

The example market channel estimator 102 of FIG. 1 retrieves market channel information based on the subregion(s) (block 618). For example, the market channel estimator 102 may request market channel information from the market channel database 114 based on location(s) of the subregion(s) and/or characteristics of the subregion(s). The market channel database 114 provides matching market channel information to the market channel estimator 102, which may use the market channel information to establish estimates of market channels (e.g., estimated numbers of a product available for sale in the geographic area or subregion, estimated numbers of a product type available for sale in the geographic area or subregion, estimated numbers of a retail store type available for sale in the geographic area or subregion, lower limits or bounds on market channel estimates, and/or upper limits or bounds on market channel estimates).

For example, if multiple geographic areas are found to be similar to the geographic area of interest 108 based on the aerial image, the example market channel estimator 102 may identify a lowest value of the market channel of interest in the similar geographic areas. The example market channel estimator 102 may then use the identified lowest value as a lower bound on the value of the market channel (e.g., a product availability, a number of products of a particular type, etc.) in the geographic area of interest 108. In other words, the market channel estimator 102 may determine that the geographic area of interest 108 is likely to have at least a minimum size for the market channel of interest. Conversely, the example market channel estimator 102 may identify a highest value as an upper bound on the value of the market channel in the geographic area of interest 108. The upper and/or lower bounds may be used to rapidly filter geographic areas for further analysis prior to expending computing resources on more precise estimates of the market channels.

The example market channel estimator 102 of FIG. 1 estimates market channel(s) for the geographic area using the market channel information (block 620). For example, the market channel estimator 102 may use the market channel information for geographic areas similar to the geographic area of interest 108 to determine an estimate for market channels, upper limits on market channels, and/or lower limits on market channels. The example instructions 600 may then end. In some examples, the market channel estimator 102 provides a report of the estimated market channels to a requesting party, such as a product manufacturer or retailer.

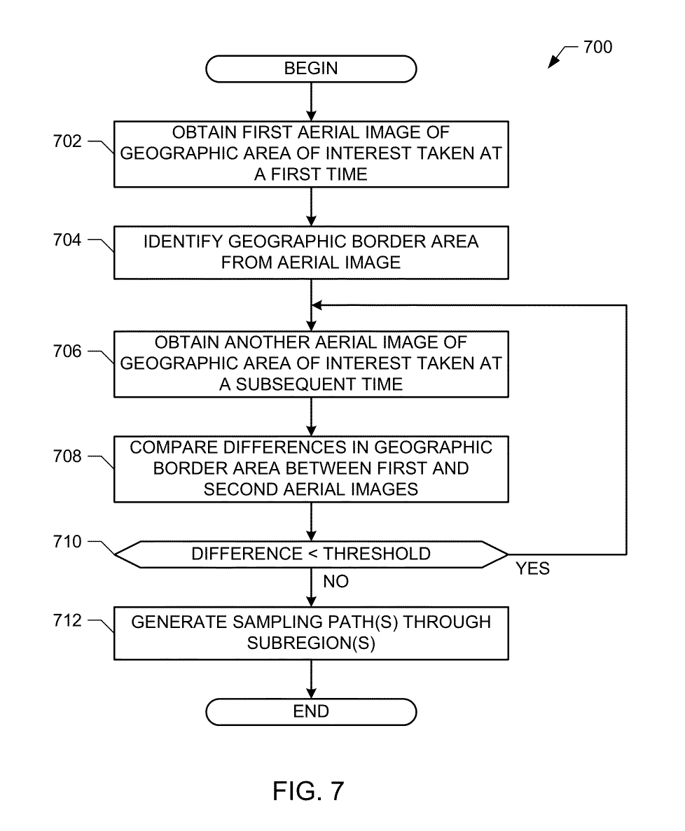

FIG. 7 is a flowchart representative of example computer readable instructions 700 which may be executed to generate a sampling path to sample a geographic area based on aerial images. The example instructions 700 may be performed to implement the example image analyzer 116, the example sampling path generator 104, and/or the example aerial image repository 110 of FIG. 1.

The example image analyzer 116 of FIG. 1 obtains a first aerial image of a geographic area of interest (e.g., the geographic area of interest 108) that was taken at a first time (block 702). The first aerial image may be obtained from the example aerial image repository 110 of FIG. 1. The image analyzer 116 (e.g., via the border area identifier 124) identifies a geographic border area in the first aerial image (block 704). The border area may be identified between an area including man-made objects and a natural area, or between areas containing man-made objects having different characteristics or classifications (e.g., different estimated average socioeconomic statuses). Block 704 may be performed in a manner similar to, for example, blocks 604-616 of FIG. 6, the description of which is not repeated here to avoid redundancy.

The example image analyzer 116 obtains another aerial image of the geographic area of interest 108 that was taken at time subsequent to the first time (block 706). For example, the image analyzer 116 may obtain a second aerial image that includes the geographic area of interest 108 taken long enough after the first image for at least a threshold amount (e.g., an observable amount) of development of the geographic area of interest 108 to have occurred. The example image analyzer 116 may crop, enhance, and/or otherwise process portions of the first and/or second images to limit analysis to the geographic area of interest. For example, the first and second images may vary by resolution, height from which the images were taken, angle from which the images were taken, and/or contents (e.g., geographic boundaries) of the image.

The example image change detector 126 of FIG. 1 compares differences in the images of the geographic border area (block 708). For example, the image change detector 126 may identify changes in the man-made objects (e.g., additions, modifications, and/or destruction of buildings) and/or changes to the border between different subregions (e.g., conversion of land from natural area to developed area). The image change detector 126 determines whether there is at least a threshold change between the images (block 710). For example, the threshold change may be based on a lower area of land that has been converted from natural area to developed area, or a minimum number of buildings that have been added, modified, and/or removed from the geographic area. If there is not at least a threshold difference (block 710), control returns to block 706 to obtain another aerial image of the geographic area of interest 108 (e.g., taken a later date).

If there is at least a threshold difference (block 710), the example sampling path generator 104 generates sampling path(s) through the subregion(s) (block 712). For example, the sampling path generator 104 may determine an efficient sampling path to have a low (e g , minimum) cost and to adequately represent the geographic area of interest 108 and/or the subregion(s). The sampling path is used by one or more persons to perform sampling of market channels (e.g., products, product types, retail stores, etc.) in the geographic area of interest. The example instructions 700 may then end.

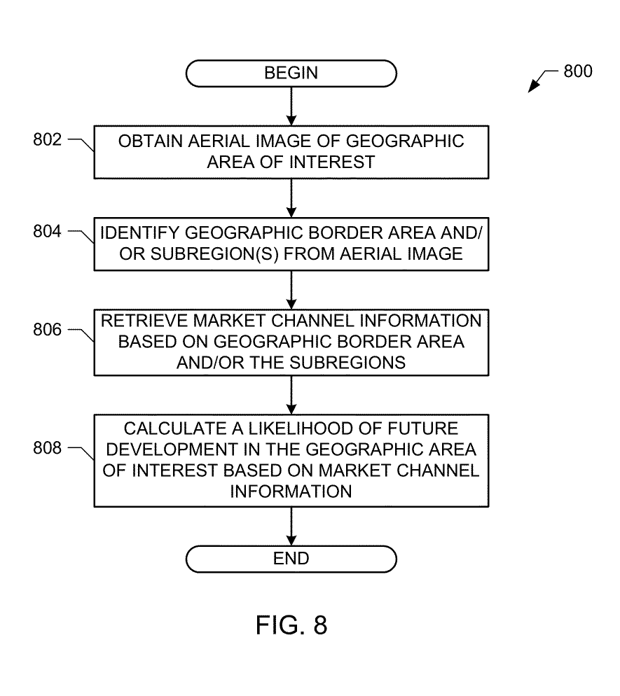

FIG. 8 is a flowchart representative of example computer readable instructions 800 which may be executed to estimate development of a geographic area based on aerial images. The example instructions 800 of FIG. 8 may be performed to implement the example image analyzer 116, the example aerial image repository 110, the example market channel database 114, and/or the example development estimator 106 of FIG. 1.

The example image analyzer 116 obtains an aerial image of a geographic area of interest (e.g., the geographic area of interest 108 of FIG. 1) (block 802). For example, the image analyzer 116 may request and receive the aerial image from the aerial image repository 110 of FIG. 1. The image analyzer 116 (e.g., via the border area identifier 124) identifies a geographic border area and/or subregion(s) in the aerial image (block 804). The border area may be identified between a subregion including man-made objects and a natural area, or between subregions containing man-made objects having different characteristics or classifications (e.g., different estimated average socioeconomic statuses). Block 804 may be performed in a manner similar to, for example, blocks 604-616 of FIG. 6, the description of which is not repeated here to avoid redundancy.

The example development estimator 106 of FIG. 1 retrieves market channel information based on subregions (block 806). For example, the development estimator 106 may request market channel information from the market channel database 114 based on location(s) of the subregion(s) and/or characteristics of the subregion(s). The market channel database 114 provides matching market channel information to the development estimator 106. The market channel information may include market channel information for identical or similar regions at multiple points in time to enable the estimation of future development based on prior characteristics of an area.

The example development estimator 106 calculates a likelihood of future development of the geographic area of interest 108 (e.g., development of the subregion(s), development of a geographic border area, etc.) based on the market channel information (block 808). For example, calculating the likelihood of future development may include identifying a similar geographic area at a time in the past and for which development information since that time is available. The similar geographic area may be identified based on, for example, classifications of objects in the aerial image, a border between subregions, and/or any other characteristics of the geographic area and/or the aerial image. The example development estimator 106 determines the development of the similar geographic area (e.g., development from a time at which the similar geographic area was similar to the geographic area of interest to a more recent time). The example development estimator 106 may then calculate the likelihood of future development based on the development of the second geographic area. In other words, the example development estimator 106 may use development information for similar areas to determine the likely development of the geographic area of interest 108. Example estimates or predictions may include growth in average socioeconomic status, growth in market channels, estimated numbers of a product available for sale in the geographic area or subregion at a later time, estimated numbers of a product type available for sale in the geographic area or subregion at a later time, estimated numbers of a retail store type available for sale in the geographic area or subregion, lower limits on market channels at a later time, and/or upper limits on market channels at a later time. The example instructions 800 may then end. In some examples, the development estimator 106 outputs an estimated development of the geographic area of interest 108, which may be used by product manufacturers and/or retailers to plan for future retail and/or supply needs in the geographic area of interest 108.

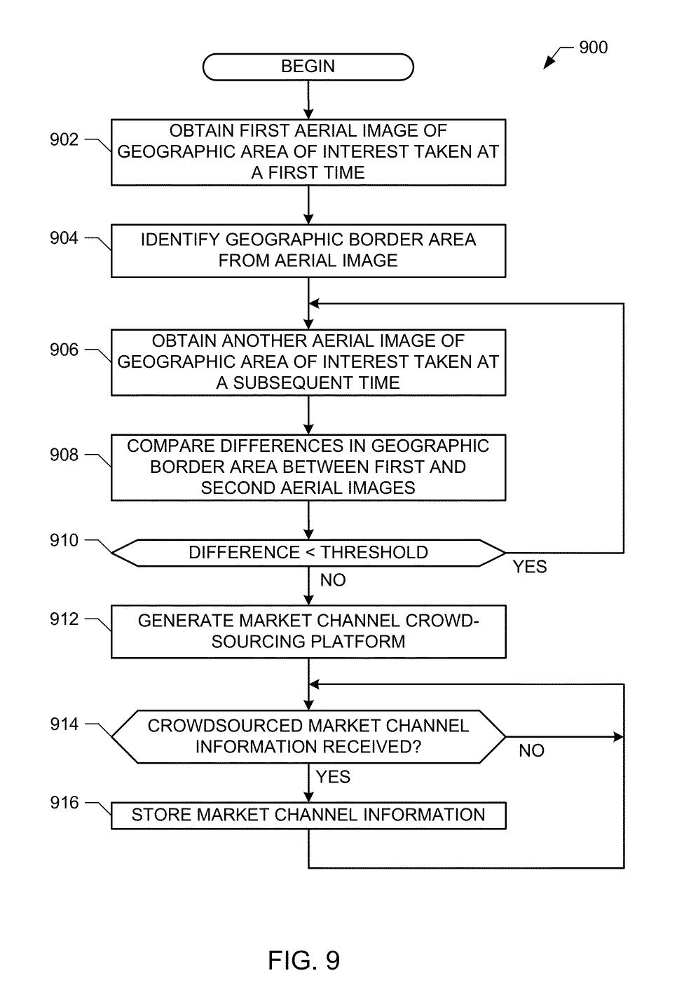

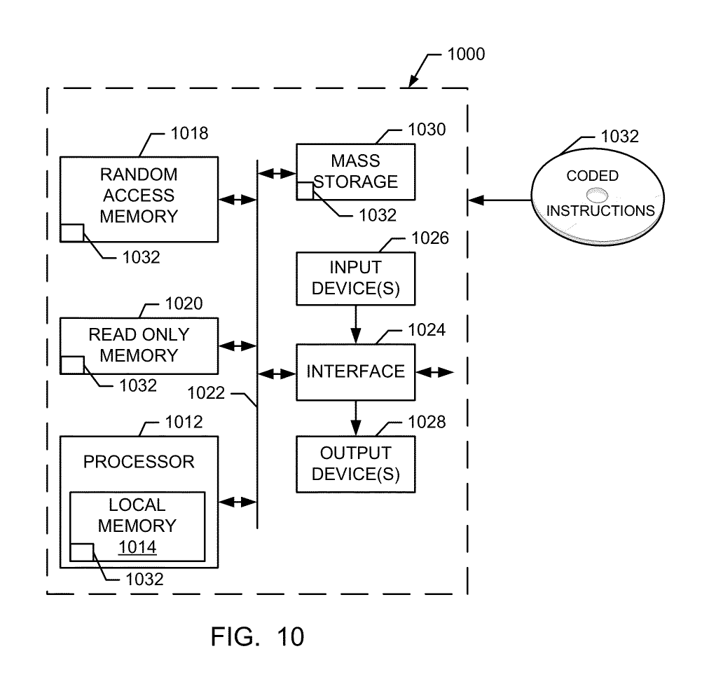

FIG. 9 is a flowchart representative of example computer readable instructions 900 which may be executed to initiate crowdsourcing of information about a geographic area based on aerial images. The example instructions 900 of FIG. 9 may be performed to implement the example image analyzer 116, the example aerial image repository 110, and/or the example crowdsourcing initiator 128 of FIG. 1.

The example image analyzer 116 (e.g., via the image change detector 126 and/or the border area identifier 124) perform blocks 902-910 of FIG. 9 to obtain aerial images of a geographic area of interest (e.g., the geographic area of interest 108 of FIG. 1) and determine whether there is at least a threshold difference between two or more images of the geographic area of interest 108. Blocks 902-910 may be performed in a manner similar or identical to blocks 702-710 of FIG. 7 and, to avoid redundant description, are not described again.

When the example image change detector 126 of FIG. 1 detects at least a threshold difference between first and second aerial images of the geographic area of interest (block 910), the example crowdsourcing initiator 128 of FIG. 1 generates a market channel crowdsourcing platform (block 912). For example, the crowdsourcing initiator 128 may generate (e.g., automatically and/or manually) an interactive web page that may be accessed by members of the public to provide market channel information. The interactive web page may include, for example, a map of the geographical area of interest and data entry fields to enable a person to enter product and/or retail store data and to designate a location in the geographical area with which the product and/or retail store is associated (e.g., where the product and/or retail store were observed). In some examples, persons may be required to log in, register, and/or otherwise verify the accuracy of the provided information. Persons entering information may be rewarded with money, coupons, and/or other items of value in exchange for entering accurate information. In some examples, the crowdsourcing initiator 128 automatically generates an interactive web page to correspond to the geographic area of interest. The automatically generated web page may automatically include code to link to a mapping service (e.g., the Google Maps application programming interface (API)), code to interface to data storage, and code to permit users to input and submit the data in the web page. Additionally or alternatively, some or all of the web page code may be developed manually.

The example crowdsourcing initiator 128 determines whether crowdsourced market channel information has been received (block 914). For example, the crowdsourcing initiator 128 may receive crowdsourced market channel information submissions from the market channel crowdsourcing platform. If crowdsourced market channel information has not been received (block 914), control returns to block 914 to await crowdsourced market channel information. When crowdsourced market channel information is received (block 914), the example crowdsourcing initiator 128 stores the market channel information in association with the example geographic area of interest 108 (block 916). For example, the crowdsourcing initiator 128 may store the received market channel information in the market channel database 114. In some examples, crowdsourced market channel information is flagged for subsequent verification (e.g., verification via additional crowdsourced market channel information and/or via sampling).

FIG. 10 is a block diagram of an example processor platform 1000 capable of executing the instructions of FIGS. 6, 7, 8, and/or 9 to implement the apparatus of FIG. 1. The processor platform 1000 can be, for example, a server, a personal computer, a mobile device (e.g., a cell phone, a smart phone, a tablet such as an iPad™), a personal digital assistant (PDA), or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1020 of the illustrated example, thus, typically includes a graphics driver card.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIGS. 6, 7, 8, and/or 9 may be stored in the mass storage device 1028, in the volatile memory 1014, in the non-volatile memory 1016, and/or on a removable tangible computer readable storage medium such as a CD or DVD.

From the foregoing, it will appreciate that methods, apparatus and articles of manufacture have been described which advantageously estimate market channels of geographic areas. Example methods, apparatus, and articles of manufacture disclosed herein are more cost-effective than traditional methods of sampling while achieving similar or better accuracy. Furthermore, example methods, apparatus, and articles of manufacture disclosed herein may be used to more effectively and/or efficiently target traditional sampling methods to geographic areas having a higher likelihood of developing market channels (e.g., emerging markets). Example methods, apparatus, and articles of manufacture disclosed herein may be used in places in which traditional sampling methods are difficult or impossible due to geopolitical and/or other reasons.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. A method, comprising:
determining, using a processor, whether a first element in an aerial image of a geographic area represents a man-made object;
determining, using the processor, whether a second element in the aerial image represents a natural object; and
estimating a market channel for the geographic area based on a second market channel for a second geographic area when the first element represents a man-made object and the second element represents a natural object.

2. A method as defined in claim 1, wherein estimating the market channel comprises estimating at least one of a number of stores or a type in the geographic area.

3. A method as defined in claim 1, wherein estimating the market channel comprises estimating at least one of a number of a designated product available for purchase in the geographic area or a number of different products of a designated type that are available for purchase in the geographic area.

4. A method as defined in claim 1, wherein estimating the market channel comprises determining at least one of an upper limit or a lower limit on the market channel based on the second market channel.

5. A method as defined in claim 1, further comprising determining a path through the geographic area to be sampled based on a market channel estimation for the geographic area.

6. A method as defined in claim 1, further comprising generating a Radon transform of the aerial image, wherein determining whether the first element represents a man-made object is based on the Radon transform.

7. A method as defined in claim 1, further comprising:
comparing the aerial image to a second aerial image of the geographic area; and
sampling the market channel when there is at least a threshold difference between the aerial image and the second aerial image.

8-16. (canceled)

17. An apparatus, comprising:
a man-made object identifier to determine whether a first element in an aerial image of a geographic area represents a man-made object;
a natural object identifier to determine whether a second element in the aerial image represents a natural object; and
a channel estimator to estimating a market channel for the geographic area based on a second market channel for a second geographic area when the first element represents a man-made object and the second element represents a natural object.

18. An apparatus as defined in claim 17, further comprising a border area identifier to identify a border between a first subregion including the first element and a second subregion including the second element, the channel estimator to estimate the market channel for the geographic area in response to the border area identifier identifying the border.

19. An apparatus as defined in claim 17, wherein the channel estimator is to estimate at least one of a number of stores or a type of a store in the geographic area.

20. An apparatus as defined in claim 17, wherein the channel estimator is to estimate at least one of a number of a designated product available for purchase in the geographic area or a number of different products of a designated type that are available for purchase in the geographic area.

21. An apparatus as defined in claim 17, wherein the channel estimator is to determine at least one of an upper limit or a lower limit on the market channel based on the second market channel.

22. An apparatus as defined in claim 17, further comprising a sampling path generator to determine a path to be sampled through the geographic area based on a market channel estimation for the geographic area.

23. An apparatus as defined in claim 17, wherein the man-made object identifier is to generate a Radon transform of the aerial image, the man-made object identifier to determine whether the first element represents a man-made object based on the Radon transform.

24-31. (canceled)

32. A tangible computer readable storage medium comprising computer readable instructions which, when executed, cause a processor to at least:
determine whether a first element in an aerial image of a geographic area represents a man-made object;
determine whether a second element in the aerial image represents a natural object; and
estimate a market channel for the geographic area based on a second market channel for a second geographic area when the first element represents a man-made object and the second element represents a natural object.

33. A storage medium as defined in claim 32, wherein the instructions are to cause the processor to estimate the market channel by estimating at least one of a number of stores or a type of a store in the geographic area.

34. A storage medium as defined in claim 32, wherein the instructions are to cause the processor to estimate the market channel by estimating at least one of a number of a designated product available for purchase in the geographic area or a number of different products of a designated type that are available for purchase in the geographic area.

35. A storage medium as defined in claim 32, wherein the instructions are to cause the processor to estimate the market channel by determining at least one of an upper limit or a lower limit on the market channel based on the second market channel.

36. A storage medium as defined in claim 32, wherein the instructions are further to cause the processor to determine a path through the geographic area to be sampled based on a market channel estimation for the geographic area.

37. A storage medium as defined in claim 32, wherein the instructions are further to cause the processor to generate a Radon transform of the aerial image, wherein determining whether the first element represents a man-made object is based on the Radon transform.

38. A storage medium as defined in claim 32, wherein the instructions are further to cause the processor to:
compare the aerial image to a second aerial image of the geographic area; and
sample the market channel when there is at least a threshold difference between the aerial image and the second aerial image.

39-46. (canceled)
